(19) United States
(12) Patent Application Publication
(10) Pub. No.: US 2023/0190560 A1
(43) Pub. Date: Jun. 22, 2023

(54) MANIFOLD CABINET AND METHOD OF OPERATION

(71) Applicant: Powerex, Inc./The Scott Fetzer Company, Harrison, OH (US)

(72) Inventor: Abbey Soulek, Liberty Township, OH (US)

(21) Appl. No.: 18/085,892

(22) Filed: Dec. 21, 2022

Related U.S. Application Data
(60) Provisional application No. 63/292,554, filed on Dec. 22, 2021.

(51) Int. Cl. A61G 12/00

(52) U.S. Cl. CPC A61G 12/002

(57) ABSTRACT

A manifold cabinet is disclosed herein. The manifold cabinet includes a support plate having a support surface statically supporting a plurality of manifold components, the support surface coupling first and second connection surfaces to each other, the connection surfaces transverse to the support surface, and a cabinet front defining a void within which the plurality of manifold components reside. The cabinet front includes walls that define a first space and a cabinet door. The walls are removably couplable to the connecting surfaces of the support plate, the walls defining a plurality of voids, wherein, one or more ports of the manifold components extend through the plurality of voids and outside the manifold cabinet. The cabinet door is hingedly connected to the walls and extends between an open position to a closed position, wherein in the closed position, the walls, the cabinet door, and the support plate define an enclosed space.

### CROSS REFERENCES TO RELATED APPLICATIONS

The following application claims priority under 35 U.S.C. 119(e) to co-pending U.S. Provisional Patent Application Ser. No. 63/292,554 filed Dec. 22, 2021 entitled MANIFOLD CABINET AND METHOD OF OPERATION. The above-identified application is incorporated herein by reference in its entirety for all purposes.

### TECHNICAL FIELD

The present disclosure relates to a manifold cabinet and method of operation, and more particularly, a manifold cabinet having a supporting main plate that facilitates access to internal parts for maintenance and repair.

### BACKGROUND

Enclosures, especially sheet metal enclosures for medical gas systems have limited access to repair internal components. Typically, the enclosure has a single access point, and various internal components coupled to multiple locations within the enclosure.

### SUMMARY

One aspect of the present disclosure includes a manifold cabinet having a support plate having a support surface statically supporting a plurality of manifold components, the support surface coupling first and second connection surfaces to each other, the connection surfaces transverse to the support surface, and a cabinet front removably couplable to the support plate, the cabinet front defining a void within which the plurality of manifold components reside. The cabinet front includes walls that define a first space and a cabinet door. The walls are removably couplable to the connecting surfaces of the support plate, the walls defining a plurality of voids, wherein, one or more ports of the manifold components extend through the plurality of voids and outside the manifold cabinet when the cabinet front is coupled to the support plate. The cabinet door is hingedly connected to the walls and extends between an open position to a closed position, wherein in the closed position, the walls, the cabinet door, and the support plate define an enclosed space.

Another aspect of the present disclosure includes a manifold cabinet having a support plate having a support surface statically supporting a plurality of manifold components, the support surface opposite a rear surface, the rear surface attachable to a static surface, the support plate coupled to first and second flanges that define first and second planar connection surfaces, the first and second planar connection surfaces facing away from each other and facing away from the support surface and a cabinet front removably couplable to the support plate via the first and second planar connection surfaces, the cabinet front defining a manifold void within which the plurality of manifold components reside. The cabinet front comprising walls that define a first space, the walls are removably couplable to the connecting surfaces of the support plate, the walls defining a plurality of access voids, wherein, one or more ports of the manifold components extend through the plurality of access voids, and extend outside the manifold cabinet when the cabinet front is coupled to the support plate, and a cabinet door hingedly connected to the walls, the cabinet door supporting a display screen, the manifold components communicating information to the display screen though at least one of shortwave radio transmission, WIFI, or a direct connection, wherein the display screen displays said information, the cabinet door extending from an open position to a closed position, wherein in the closed position, the walls, the cabinet door, and the support plate define an enclosed space.

Yet another aspect of the present disclosure includes a manifold cabinet having a support plate having a support surface statically supporting a plurality of manifold components, the support surface opposite a rear surface, the rear surface attachable to a static surface, the support plate coupled to first and second flanges that define first and second planar connection surfaces, the first and second planar connection surfaces facing away from each other and facing away from the support surface, and a cabinet front removably couplable to the support plate via the first and second planar connection surfaces, the cabinet front defining a manifold void within which the plurality of manifold components reside. The cabinet front having walls that define a first space, the walls comprise a top wall, a left side wall, a right side wall, and a bottom wall, the top and bottom walls spacing the right-side wall from the left side wall, and coupling the right-side wall to the left side wall, the walls are removably couplable to the connecting surfaces of the support plate, each of the top, bottom, left side and right side walls defining at least one access void, wherein, one or more ports of the manifold components extend through the access voids, and extend outside the manifold cabinet when the cabinet front is coupled to the support plate, and a cabinet door hingedly connected to at least one of the top, bottom, right side, or left side wall and interacts with another of the bottom, right side, or left side to close the cabinet door, the cabinet door supporting a display screen, the manifold components communicating information to the display screen though at least one of shortwave radio transmission, WIFI, or a direct connection, wherein the display screen displays said information, the cabinet door extending from an open position to a closed position, wherein in the closed position, the walls, the cabinet door, and the support plate define an enclosed space.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 is a perspective view of a manifold cabinet partially disassembled in accordance with one example embodiment;

FIG. 2 is a front elevation view of a support plate of a manifold cabinet in accordance with one example embodiment;

FIG. 3 is an elevation view of a front of a manifold cabinet in a closed position in accordance with one example embodiment;

FIG. 4 is an elevation view of a front of a manifold cabinet in an open position in accordance with one example embodiment;

FIG. 5 is an elevation view of a left side of a manifold cabinet partially disassembled in accordance with one example embodiment;

FIG. 6 is a left side elevation view of a support plate of a manifold cabinet in accordance with one example embodiment;

FIG. 7 is a left side elevation view of a manifold cabinet in a closed position in accordance with one example embodiment; and

FIG. 8 is a plan view of a top of a manifold cabinet in an open position in accordance with one example embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to a manifold cabinet and method of operation, and more particularly, a manifold cabinet having a supporting main plate that facilitates access to internal parts for maintenance and repair.

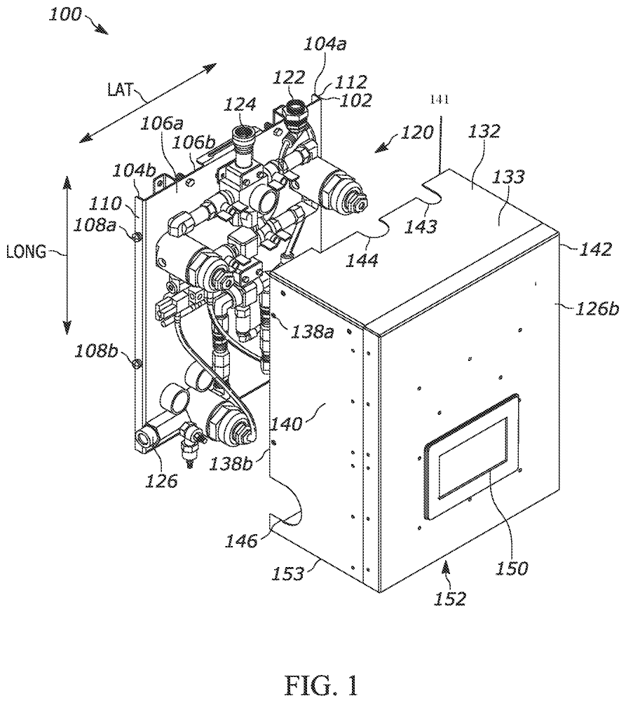

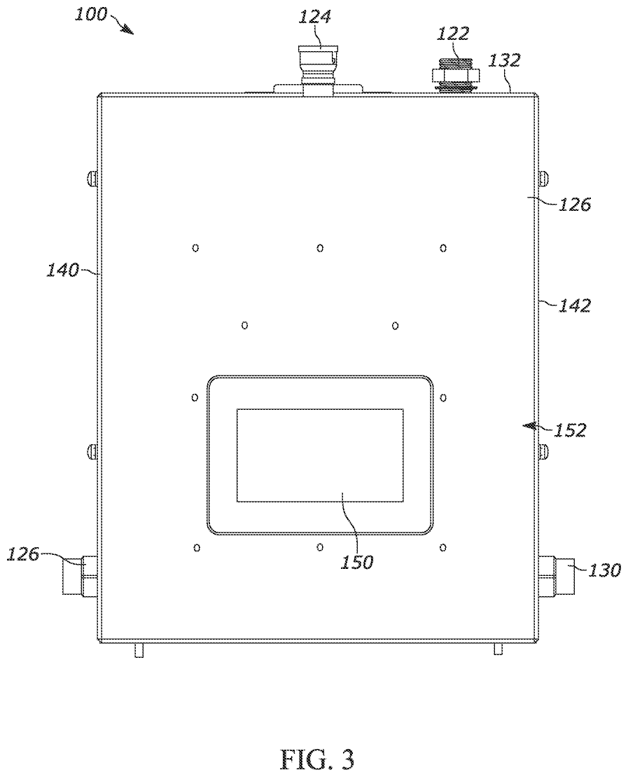

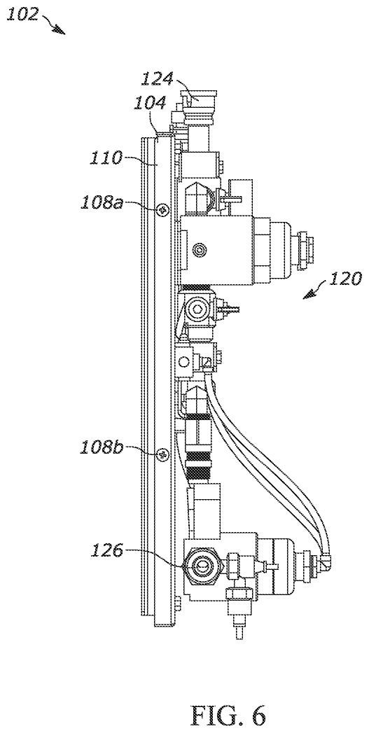

A manifold cabinet 100 having a support plate 102 couplable to a cabinet front 132 is disclosed herein. In the illustrated example embodiments of FIGS. 1-8, the manifold cabinet 100 is illustrated with the cabinet front 132 coupled to and uncoupled from the support plate 102. In one example embodiment, the cabinet front 132 and the support plate 102 are made of metal, such as steel, aluminum, or the like, and could equally be made from a polymer such as plastic or any combination of metals and/or polymers.

In another embodiment, the manifold cabinet 100 houses manifold components 120, including fluid or gas regulators, tubing, inputs, outputs, pressure gauges and the like. The support plate 102 supports and is coupled to the manifold components 120 such that absent the cabinet front 132, the support plate supports the manifold components in a continuous or static position.

Further, responsive to the support plate 102 being coupled to the cabinet front 132, the support plate 102 supports the manifold components 120 such that the manifold components communicate with the cabinet front and/or a display screen 150 supported by the cabinet front. The manifold components 120 communicate with the display screen 150 though at least one of shortwave radio transmission, WIFI, or a direct connection (e.g., through a connection port, wire, etc.). In one example embodiment, the support plate 102 secures the various manifold components 120 into place such that the components interact with the cabinet front 132 to communicate information about the manifold components, such as pressure, volume, identity of the fluid in a given manifold component, etc. In this example embodiment, a connection port (not shown) supported on one of the support plates 102 or the cabinet front 132 is complementary to a connection insert (not shown) supported on the other side of the support plate 102 or cabinet front 132, such that when the support plate 102 is coupled to the cabinet front 132, the connection port houses the connection insert.

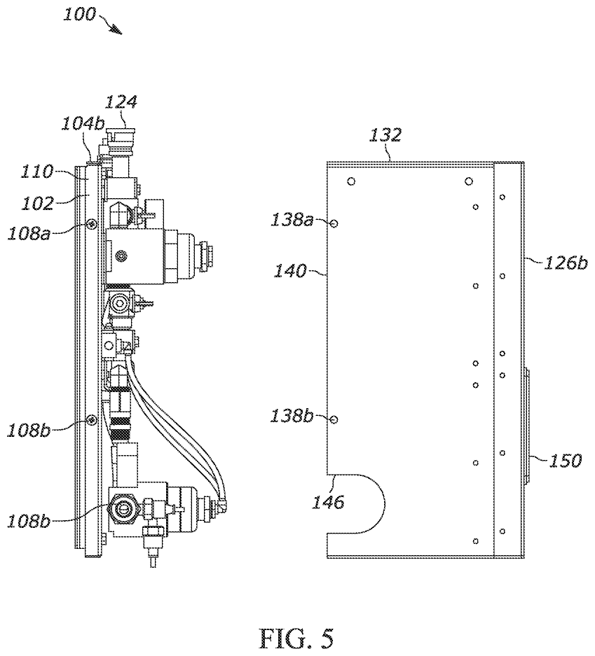

Referring now to FIGS. 1 and 5, the support plate 102 is uncoupled from the cabinet front 132. The support plate 102 has a front surface 106a that supports the manifold components 120. The front surface 106a is opposite a rear surface 106b and extends longitudinally along a longitudinal axis LONG and laterally along a lateral axis LAT. In one example embodiment, the rear surface 106b attaches to a surface, such as a wall, or other horizontal or vertical surface. In this embodiment, the support plate 102 supporting the manifold components 120 remains attached to the front surface 106a when the cabinet front 132 is separated from the support plate, providing easy and full access to the manifold components.

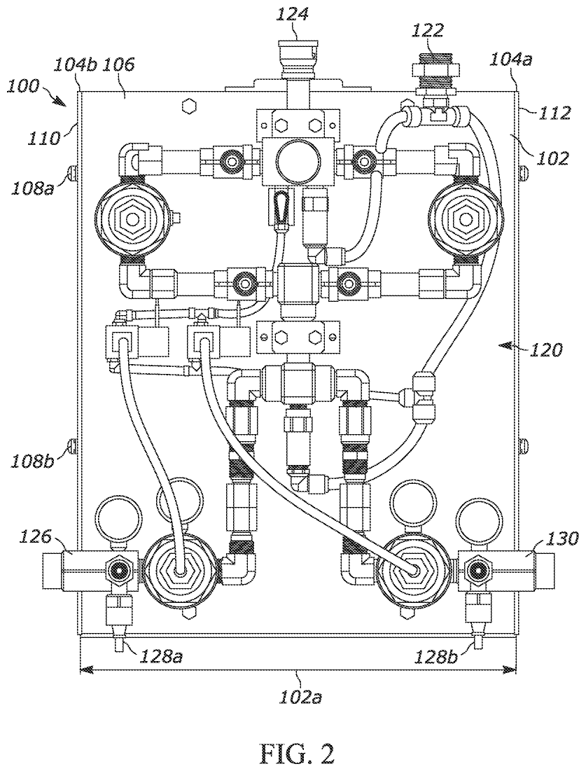

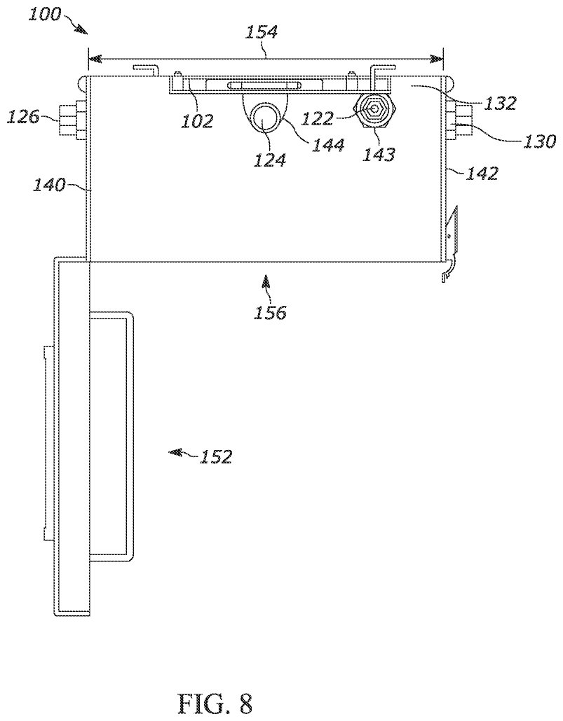

The support plate 102 defines first and second flanges 104a, 104b that extend along the longitudinal axis LONG of the support plate. In one example embodiment, the first and second flanges 104a, 104b define first and second planar connecting surfaces 110, 112. In one example embodiment, the first and second planar connecting surfaces 110, 112 are at least one of transverse or perpendicular to the front surface 106a and or the rear surface 106b. In one example embodiment, the first and second planar connecting surfaces 110, 112 are spaced from each other by the front surface 106a. In another example embodiment, the first and second planar connecting surfaces 110, 112 are spaced at a support distance 102a (see FIG. 2) from each other, wherein the support distance is less than or equal to a width 154 (see FIG. 8) of the cabinet front 132. In another example embodiment, the support distance 102a is about 0.2 cm to about 1 cm less than the width 154.

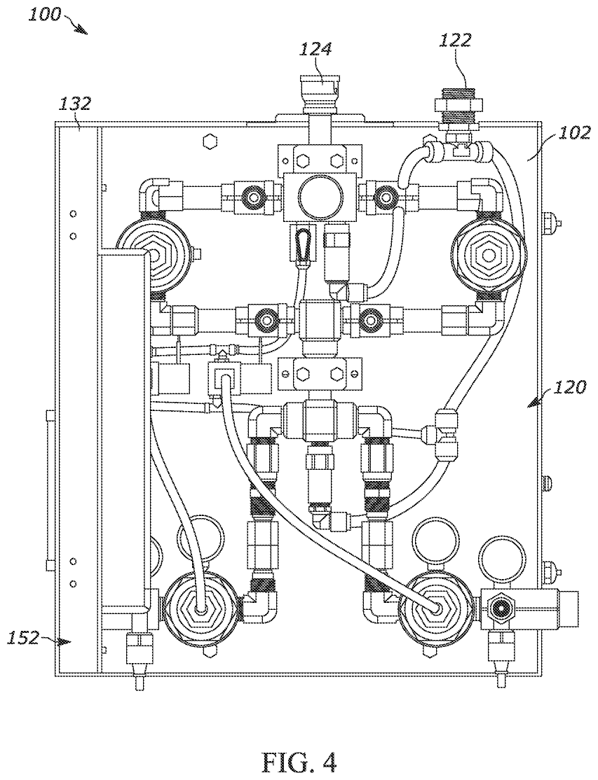

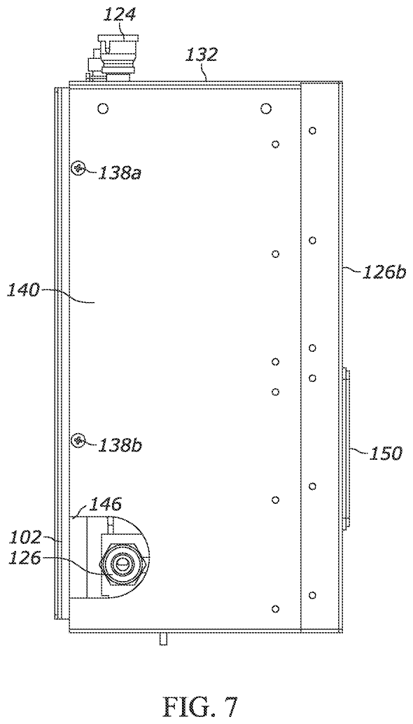

The cabinet front 132 as illustrated in FIGS. 1, 3-5, and 7-8, has a generally three-dimensional rectangular shape. The cabinet front 132 defines a void 156 in which the support plate 102 and the manifold components 120 reside. The cabinet front 132 also includes a cabinet door 152. The void 156 is partially defined by a top wall 133 and a bottom wall 153 spacing a right-side wall 142 from a left side wall 140, the top wall and the bottom wall connecting the right and left side walls. The cabinet door 152 is hingedly connected to at least one of the top, bottom, right side, or left side wall 133, 153, 142, 140. In the illustrated example embodiment of FIGS. 4 and 8, the cabinet door 152 is hingedly connected to the left side wall 140 and interacts with the right-side wall 142 to close the cabinet door. The cabinet door 152 defines a front side wall 126b that defines the void 156 (see FIGS. 7 and 8). Thus, the manifold component 120 are accessible by removing the cabinet front 132 from the support plate 102 and by opening the cabinet door 152.

In one example embodiment, the first and second planar connecting surfaces 110, 112 support connectors 108a, 108b (e.g., screws, tension clips, lug nuts, etc.). Connectors 108 shown on the first planar surface 110 are substantially the same as connectors on the second planar surface 112 (not shown). The connectors 108 are complementary to one or more connector areas 138a, 138b, that are defined on the right side and left side walls 140, 142, respectively. The connector areas 138b shown on the left side wall 142 are substantially the same as connector areas 138a on the right-side wall 140 (not shown). In one example, the connector areas 138 are through-holes, through which the connectors 108 extend through and are secured. In another example embodiment, the connector areas 138 are indents, within which the connectors 108 frictionally reside.

Referring now to FIGS. 1, 3, 5, and 8, the cabinet front 132 defines voids 143, 144, 146 through which various manifold components 120 extend. The voids 143, 144, 146 comprise a slot or intrusion into one of the left, right, top, and/or bottom side walls 140, 142, 133, 153. The voids 143, 144, 146 are indentations in the substantially rectangular shape of the cabinet front 132. The voids 143, 144, 146 define arced, oval, square, rectangular, and/or polygonal shapes. In one example embodiment, the voids 143, 144, 146 are defined in exterior perimeter 141 (see FIG. 1) of the left, right, top, and/or bottom side walls 140, 142, 133, 153. In one example embodiment, the voids 143, 144, 146 extend from the exterior perimeter 141 toward the cabinet door 132. Except for where there are voids 143, 144, 146 defined, the left, right, top, and/or bottom side walls 140, 142, 133, 153 interact with the support plate 102 when the support plate is coupled to the cabinet front 132.

In one example embodiment, the input/export ports 122, 124, 126 extend through the voids 143, 144, 146 when the cabinet front 132 is coupled to the support plate 102. The input/export ports 122, 124, 126 extending through the voids 143, 144, 146 allow for external fluid inputs or outputs to connect to the manifold components 120. The voids 143, 144, 146 are positioned to allow for easy removal of the cabinet front 132 from the support plate 102, wherein the manifold components 120 do not have to be disconnected to remove the cabinet front. As illustrated in FIG. 2, additional input/export ports 128a, 128b, and 130 are contemplated, wherein additional voids (not shown) are defined within the cabinet front 132 to allow for the additional input/export ports to extend outside the manifold cabinet 100.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A manifold cabinet comprising:
a support plate having a support surface statically supporting a plurality of manifold components, the support surface coupling first and second connection surfaces to each other, the connection surfaces transverse to the support surface; and
a cabinet front removably couplable to the support plate, the cabinet front defining a manifold void within which the plurality of manifold components reside, the cabinet front comprising:
walls that define a first space, the walls are removably couplable to the connecting surfaces of the support plate, the walls defining a plurality of access voids, wherein, one or more ports of the manifold components extend through the plurality of access voids, and extend outside the manifold cabinet when the cabinet front is coupled to the support plate; and
a cabinet door hingedly connected to the walls, the cabinet door extending from an open position to a closed position, wherein in the closed position, the walls, the cabinet door, and the support plate define an enclosed space.

2. The manifold cabinet of claim 1, wherein the connection surfaces are perpendicular to the support surface.

3. The manifold cabinet of claim 1, wherein the connection surfaces interact with internal surfaces of the walls when the support plate is coupled to the cabinet front.

4. The manifold cabinet of claim 1, comprising first and second flanges that define the connection surfaces.

5. The manifold cabinet of claim 1, wherein the connection surfaces comprise planar surfaces that extend perpendicular to the support surface.

6. The manifold cabinet of claim 1, wherein the connection surfaces are spaced a support distance from each other, and wherein the support distance is less than or equal to a width of the cabinet front.

7. The manifold cabinet of claim 1, wherein the manifold components comprise one or more of fluid or gas regulators, tubing, inputs, outputs, or pressure gauges.

8. The manifold cabinet of claim 1, wherein the cabinet door supports a display screen.

9. The manifold cabinet of claim 8, wherein the manifold components communicate with the display screen though at least one of shortwave radio transmission, WIFI, or a direct connection.

10. The manifold cabinet of claim 1, wherein the manifold void is partially defined by a top wall and a bottom wall, the top and bottom walls spacing a right side wall from a left side wall and coupling the right side wall to the left side wall.

11. The manifold cabinet of claim 10, wherein the cabinet door is hingedly connected to at least one of the top, bottom, right side, or left side wall and interacts with another of the bottom, right side, or left side to close the cabinet door.

12. The manifold cabinet of claim 10, wherein at least one access void is defined in the bottom, right side, and left side walls, the at least one access void defining an intrusion into the respective bottom, right side, and left side walls.

13. The manifold cabinet of claim 10, wherein at least one access void is defined in the bottom, right side, and left side walls, the at least one access void defining an intrusion into an exterior perimeter of the respective bottom, right side, and left side walls.

14. The manifold cabinet of claim 10, wherein at least one access void is defined in the bottom, right side, and left side walls, the at least one access void defining an intrusion extending toward the cabinet door into an exterior perimeter of the respective bottom, right side, and left side walls.

15. The manifold cabinet of claim 1, wherein the support plate having a rear surface opposite the support surface, wherein the rear surface is couplable to a wall when in use.

16. A manifold cabinet comprising:
a support plate having a support surface statically supporting a plurality of manifold components, the support surface opposite a rear surface, the rear surface attachable to a static surface, the support plate coupled to first and second flanges that define first and second planar connection surfaces, the first and second planar connection surfaces facing away from each other and facing away from the support surface; and
a cabinet front removably couplable to the support plate via the first and second planar connection surfaces, the cabinet front defining a manifold void within which the plurality of manifold components reside, the cabinet front comprising:
walls that define a first space, the walls are removably couplable to the connecting surfaces of the support plate, the walls defining a plurality of access voids, wherein, one or more ports of the manifold components extend through the plurality of access voids, and extend outside the manifold cabinet when the cabinet front is coupled to the support plate; and
a cabinet door hingedly connected to the walls, the cabinet door supporting a display screen, the manifold components communicating information to the display screen though at least one of shortwave radio transmission, WIFI, or a direct connection, wherein the display screen displays said information, the cabinet door extending from an open position to a closed position, wherein in the closed position, the walls, the cabinet door, and the support plate define an enclosed space.

17. The manifold cabinet of claim 16, wherein the manifold void is partially defined by a top wall and a bottom wall, the top and bottom walls spacing and coupling a right-side wall from a left side wall, wherein the cabinet door is hingedly connected to at least one of the top, bottom, right side, or left side wall and interacts with another of the bottom, right side, or left side to close the cabinet door, further, wherein at least one access void is defined in the bottom, right side, and left side walls, the at least one access void defining an intrusion extending toward the cabinet door into an exterior perimeter of the respective bottom, right side, and left side walls.

18. The manifold cabinet of claim 17, wherein the first and second planar connecting surfaces support connectors, the connectors being complementary to one or more connector areas defined on the right side and left side walls, the connectors removably connecting the cabinet front to the support plate.

19. The manifold cabinet of claim 18, wherein the connector areas are one of through-holes or indents.

20. A manifold cabinet comprising:
a support plate having a support surface statically supporting a plurality of manifold components, the support surface opposite a rear surface, the rear surface attachable to a static surface, the support plate coupled to first and second flanges that define first and second planar connection surfaces, the first and second planar connection surfaces facing away from each other and facing away from the support surface; and
a cabinet front removably couplable to the support plate via the first and second planar connection surfaces, the cabinet front defining a manifold void within which the plurality of manifold components reside, the cabinet front comprising:
walls that define a first space, the walls comprise a top wall, a left side wall, a right side wall, and a bottom wall, the top and bottom walls spacing the right-side wall from the left side wall, and coupling the right-side wall to the left side wall, the walls are removably couplable to the connecting surfaces of the support plate, each of the top, bottom, left side and right side walls defining at least one access void, wherein, one or more ports of the manifold components extend through the access voids, and extend outside the manifold cabinet when the cabinet front is coupled to the support plate; and
a cabinet door hingedly connected to at least one of the top, bottom, right side, or left side wall and interacts with another of the bottom, right side, or left side to close the cabinet door, the cabinet door supporting a display screen, the manifold components communicating information to the display screen though at least one of shortwave radio transmission, WIFI, or a direct connection, wherein the display screen displays said information, the cabinet door extending from an open position to a closed position, wherein in the closed position, the walls, the cabinet door, and the support plate define an enclosed space.
